(19) United States
(12) Patent Application Publication
(10) Pub. No.: US 2023/0220127 A1
(43) Pub. Date: Jul. 13, 2023

(54) PROCESS FOR REDUCING ETHYLENE VOLATILES DURING LDPE POLYMERIZATION

(71) Applicant: Dow Global Technologies LLC, Midland, MI (US)

(72) Inventors: Jose Ortega, Lake Jackson, TX (US); Sarat Munjal, Lake Jackson, TX (US); Sergio E. Goncalves, Houston, TX (US)

(73) Assignee: Dow Global Technologies LLC, Midland, MI (US)

(21) Appl. No.: 18/001,511

(22) PCT Filed: Jun. 3, 2021
(86) PCT No.: PCT/US2021/035632

§ 371 Date: Dec. 12, 2022

Related U.S. Application Data
(60) Provisional application No. 63/039,185, filed on Jun. 15, 2020.

(51) Int. Cl. C08F 6/00; C08F 110/02

(52) U.S. Cl. CPC C08F 6/001; C08F 110/02

(57) ABSTRACT

Embodiments of a method for reducing unreacted ethylene monomer in a low density polyethylene (LDPE) polymerization process comprises: delivering a monomer feedstock comprising ethylene monomer to a compressor system to produce a pressurized feedstock having a pressure of at least 2000 bar; passing the pressurized feedstock to at least one free radical polymerization reactor to produce a reactor effluent comprising the LDPE and unreacted ethylene monomer; and delivering the reactor effluent to a separation system comprising a first separation vessel, a second separation vessel, and a third separation vessel in series, the third separation vessel having an operating pressure of less than or equal to 0.05 bar, wherein the third separation vessel produces a separation product comprising LDPE and less than or equal to 50 ppm of the unreacted ethylene monomer, wherein there is no stripping agent added upstream of the third separation vessel.

### CROSS REFERENCE TO RELATED APPLICATIONS

This application claims priority to U.S. Provisional Patent Application No. 63/039,185, filed on Jun. 15, 2020, the entire disclosure of which is hereby incorporated by reference.

### TECHNICAL FIELD

Embodiments described herein generally relate to low density polyethylene (LDPE) polymerization processes, and specifically relate to LDPE polymerization processes which reduces unreacted ethylene monomer during LDPE polymerization.

### BACKGROUND

Like many polymerization processes, the LDPE polymerization process may have some amount of unreacted monomer at the end of the process. Consequently, the current LDPE polymerization systems use separation systems to remove unreacted ethylene monomer. Despite these separation systems, it is a continual challenge to yield an LDPE product from the last separator stage having an unreacted ethylene monomer content of less than 50 ppm. Accordingly, pellet purging, ventilation in storage silos, and/or extrusion is required downstream of the separation system to lower the unreacted monomer ethylene amount in the LDPE product to below 50 ppm.

Accordingly, there is a continual need for improved separation processes that yield an LDPE product from the separation system with an unreacted ethylene monomer amount in the LDPE product to below 50 ppm.

### SUMMARY

Embodiments of the present disclosure meet this need for a separation system that yields an LDPE product having an unreacted ethylene monomer content below 50 ppm. Specifically, embodiments of the present disclosure achieve this by utilizing a separation system having a third separation vessel under vacuum pressure and no stripping agent (e.g., water) included upstream of the third separation vessel. Without being limited to theory, the present embodiments eliminate the need for purging, reduces process costs, and improves the safety of the system.

According to one embodiment, a method for reducing unreacted ethylene monomer in a low density polyethylene (LDPE) polymerization process is provided. The method comprises: delivering a monomer feedstock comprising ethylene monomer to a compressor system to produce a pressurized feedstock having a pressure of at least 2000 bar; passing the pressurized feedstock to at least one free radical polymerization reactor to produce a reactor effluent comprising the LDPE and unreacted ethylene monomer; and delivering the reactor effluent to a separation system comprising a first separation vessel, a second separation vessel, and a third separation vessel in series, the third separation vessel having an operating pressure of less than or equal to 0.05 bar, wherein the third separation vessel produces a separation product comprising LDPE and less than or equal to 50 ppm of the unreacted ethylene monomer, wherein there is no stripping agent added upstream of the third separation vessel.

These and embodiments are described in more detail in the following Detailed Description in conjunction with the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic illustration of the present LDPE polymerization process according to one or more embodiments of the present disclosure; and

FIG. 2 is a schematic illustration of the three stage separation system utilized in the present LDPE polymerization process of FIG. 1 according to one or more embodiments of the present disclosure

### DETAILED DESCRIPTION

Specific embodiments of the present application will now be described. These embodiments are provided so that this disclosure will be thorough and complete and will fully convey the scope of the claimed subject matter to those skilled in the art.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” as used herein, refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “composition,” as used herein, refers to a mixture of materials that comprises the composition, as well as reaction products and decomposition products formed from the materials of the composition.

“Blend,” “polymer blend,” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

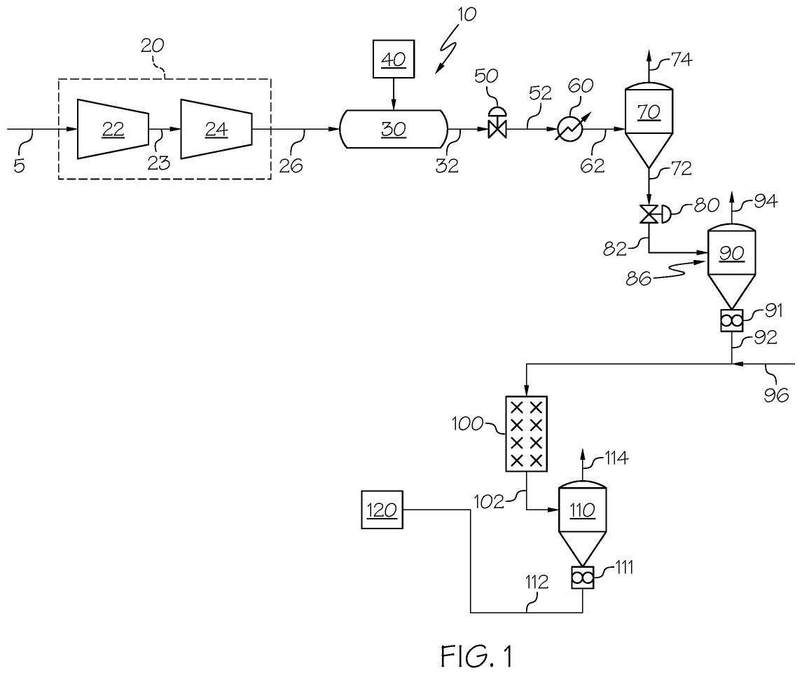

Embodiments of the present process for reducing unreacted ethylene monomer in low density polyethylene (LDPE) polymerization will now be described. Referring to the system 10 of FIG. 1, monomer feedstock 5 comprising ethylene monomer is fed to a compressor system 20 to produce a pressurized feedstock 26 having a pressure of at least 2000 bar. While not shown, it is contemplated in some embodiments that the monomer feedstock 5 may be pressurized prior to delivery to the compressor system 20. For example, the monomer feedstock may be delivered at a pressure of less than 100 bar, or less than 50 bar, or less than 20 bar. All bar measurements in the present disclosure are absolute pressure values.

Referring again to FIG. 1, the compressor system 20 may comprise one or more compressors in parallel or in series. As shown in FIG. 1, the compressor system 20 may comprise a primary compressor 22 and a secondary compressor 24 downstream of the primary compressor 22. The primary compressor 22 may pressurize the monomer feedstock 5 such that the feedstock 23 to the secondary compressor 24 has a pressure of at least 200 bar. In one or more embodiments, the primary compressor 22 may compress the monomer feedstock to a pressure of 200 to 1000 bar, or from 300 to 900 bar. To achieve this compression, the primary compressor 22 may include one or multiple compression stages,

The secondary compressor 24, which may also be called a hyper compressor, pressurizes the feedstock 23 to a pressure of at least 2000 bar, or at least 2500 bar, or at least 3000 bar. Like the primary compressor 22, the secondary compressor 24 may include one or multiple compression stages. In one or more embodiments, the secondary compressor 24 may comprise a plunger reciprocating compressor, and can consist of single or multiple compressor stage(s).

Referring again to FIG. 1, the pressurized feedstock 26 exiting the compressor system 20 is passed to at least one free radical polymerization reactor 30 to produce a reactor effluent 32 comprising the LDPE and unreacted ethylene monomer. As shown, a polymerization initiator 40 may be added to the free radical polymerization reactor 30.

The free radical polymerization reactor 30 may include one or more autoclave reactors or tubular reactors. The pressure in each autoclave or tubular reactor zone may be from 1000 to 4000 bar, or from 1500 to 3600 bar, or from 2000 to 3200 Bar. The polymerization temperature in each tubular reactor zone may be from 100 to 400° C., or from 150 to 360° C., or from 180 to 340° C. The polymerization temperature in each autoclave reactor zone may be from 150 to 300, more typically from 165 to 290, and even more typically from 180 to 280° C.

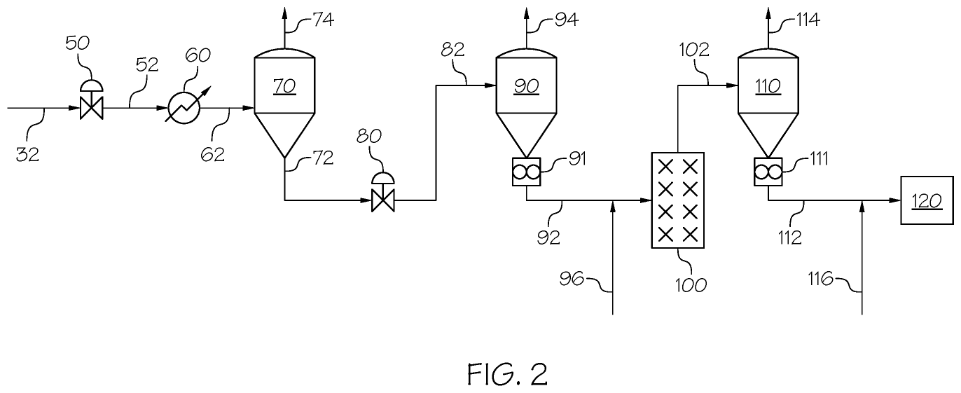

Referring to FIG. 1 and also FIG. 2, the reactor effluent 32 from the free radical polymerization reactor 30 may be fed to a separation system comprising a first separation vessel 70, a second separation vessel 90, and a third separation vessel 110 in series. However, in some embodiments, the reactor effluent 32 may be fed to a letdown valve 50, which reduces the pressure to produce a stream 52 having a pressure of 175 to 800 Bar. Subsequently, stream 52 may be fed to a downstream cooler 60 prior to feeding to the separation system, wherein the temperature of the stream 62 exiting the cooler is reduced to 180 to 280° C.

Referring again to FIG. 1, the third separation vessel 110 operates at vacuum pressure and thereby has an operating pressure of less than or equal to 0.05 bar. As this very low pressure, the third separation vessel 110 can produce a separation product 112 comprising LDPE and less than or equal to 50 ppm of the unreacted ethylene monomer, without adding stripping agent upstream of the third separation vessel 110. In further embodiments, the separation product 112 comprises less than or equal to 30 ppm of unreacted ethylene monomer.

The first separation vessel 70 may operate at a pressure of 150 to 350 bar, and a temperature of 180 to 280° C. The first separation vessel 70, which may be called a high pressure separator, separates out and discharges unreacted ethylene monomer volatiles 74, typically via the top of the first separation vessel 70, while the first separator polymer effluent 72 is discharged from the bottom of the first separation vessel 70.

As shown in the embodiments of FIGS. 1 and 2, the separation system may include a letdown valve 80 disposed between the first separation vessel 70 and the second separation vessel 90. The letdown valve 80 reduces the pressure of the first separator polymer effluent 72 to yield a stream 82 having a pressure of 1 to 5 bar. The second separation vessel 90, which may be called a low pressure separator, operates at a pressure from 1 to 5 bar, and a temperature of 180 to 260° C. The second separation vessel 90 receives a stream 82 and further separates out and discharges unreacted ethylene monomer volatiles 94, typically via the top of the second separation vessel 90, while the second separator polymer effluent 92 is discharged from the bottom of the second separation vessel 90.

Referring to another embodiment as depicted in FIGS. 1 and 2, an additive stream 86, for example, antioxidant additives, may be introduced into the second separation vessel 90. The second separation vessel 90 may be equipped with a gear pump 91 adjacent its bottom section in order to discharge the second separator polymer effluent 92 from the second separation vessel 90. Suitable gear pumps or positive displacement pumps would be familiar to the skilled person.

Additionally as shown in FIGS. 1 and 2, there may be an additive stream 96 between the second separation vessel 90 and the third separation vessel 110. The additives in additive streams 86 or 96 may include UV-stabilizers, lubricants, antioxidants, colorants, anti-statics, flame retardants and others. In one or more embodiments, these additives may include antioxidant or talc. As shown in FIGS. 1 and 2, additive stream 96 may mix with the second separator polymer effluent 92 in line and may also be mixed in a static mixer 100 disposed upstream of the third separation vessel 110. Suitable commercial embodiments of the antioxidant may include Irganox® 1010 or Irganox® 1076 from BASF. In one or more embodiments, less than 4000 ppm of additive may be included in the additive feed 96, or less than 2000 ppm, or less than 1000 ppm, or less than 200 ppm, or less than 100 ppm in the additive streams 86 or 96. Without being bound by theory, these additives added to the second separation vessel 90 or upstream of the third separation vessel 110 may mitigate potential gel formation which is possible at vacuum pressures.

Referring again to FIG. 1, there is no stripping agent added upstream of the third separation vessel 110. As used herein, “stripping agent” means water feed. By operating the third separation vessel 110 at very low vacuum pressure, the present embodiments achieve a product with very low ethylene monomer volatiles without including stripping agent between the second separation vessel 90 and third separation vessel 110. As an additional benefit, excluding stripping agent may also eliminate or reduce the need for a water separation unit downstream of the third separation vessel 110. Thus, eliminating the stripping agent (e.g., water feed) may improve process efficiency and reduce costs.

In addition to operating at vacuum pressure, the third separation vessel 110, which may be called a devolatilization reactor, may operate at a temperature from 180 to 260° C. in order to separate out unreacted ethylene monomer volatiles 114 and achieve a separation product 112 comprising LDPE and less than or equal to 50 ppm of the unreacted ethylene monomer. In further embodiments, the third separation vessel 110 may have an operating temperature of 200 to 240° C., or from 220 to 235° C. Without being limited to theory, maintaining the temperature of the third vessel below 235° C. may be beneficial to prevent gel formation at these low vacuum pressures. While vacuum pressure is defined herein as less than 0.05 bar, the third separation vessel 110 may operate at pressures from 0.01 to 0.05 bar, or 0.01 to 0.03 bar, or from 0.03 to 0.05 bar.

Similar to the second separation vessel 90, the third separation vessel 110 may include a gear pump 111 disposed adjacent its bottom section in order to discharge the separation product 112 comprising LDPE and less than or equal to 50 ppm of the unreacted ethylene monomer.

Various separation vessel structures and equipment are contemplated as suitable for the first separation vessel 70, the second separation vessel 90, and the third separation vessel 110. While various shapes are contemplated, one or more of first separation vessel 70, the second separation vessel 90, and the third separation vessel 110 may have an upper, generally cylindrical portion and a lower, inverted conical portion. In each case, the inlet to the first separation vessel 70, the second separation vessel 90, and the third separation vessel 110 may enter through the cylindrical wall on the upper part of the vessels 70, 90, 110, and the unreacted ethylene monomer volatiles evaporate and are discharged through the upper cylindrical portion whereas the polymer product is discharged from the bottom conical section.

As would be familiar to the skilled person, the third separation vessel 110 may require a heat source to flash and thereby separate the ethylene monomer volatiles from the polymer feed.

For one embodiment of the third separation vessel 110, the third separation vessel 110 may include a distributor for improved devolatilization. During devolatilization, a reduced pressure permits the unreacted ethylene monomer volatiles to flash thereby causing the LDPE polymer to separate from the unreacted ethylene monomer volatiles. This process to separate the LDPE polymer from the volatiles involves the production of foam bubbles. These bubbles generally comprise a polymeric skin which traps the volatiles. Once the bubbles grow to a sufficient size, they coalesce and burst, allowing for the volatile compounds to be released from the polymeric skin. Consequently, it may be desirable for this release of volatiles (from the bubbles) to occur in a separate device such as a distributor as opposed to a heating device.

Various compositions are contemplated for the separation vessels 70, 90, and 110. In particular, the third separation vessel 110 and the distributor may be optimized with materials directed to minimize gel formation. For example and not by way of limitation, these materials may include but are not limited to polytetrafluoroethylene or stainless steel. Various distributor designs are contemplated with some distributors yielding an efficiency at least three times better than perfect equilibrium.

Referring again to FIG. 1, the separation product 112 from the third separation vessel 110 comprises LDPE and less than or equal to 50 ppm of the unreacted ethylene monomer may be fed directly to downstream processing and/or transport 120. As used herein, the “downstream processing and/or transport” may encompass directly delivering the separation product 112 directed to a pelletization units, hydraulic conveying systems, receiving towers, granule/water separation units, dense phase conveying systems, storage containers such as railcars. However, the present process excludes purging steps, for example, venting in purge silos after the palletization. This extra step is costly and the venting is environmentally undesirable. In further embodiments, the present process may eliminate expensive extruders and monomer destruction devices, which may provide cost saving and improved process efficiency. We note that some storage systems, such as a vented railcar, may further reduce the unreacted ethylene monomer content; however, this is unnecessary as the separation product 112 from the third separation vessel 110 has sufficiently reduced unreacted ethylene monomer content.

In optional embodiments shown in FIG. 2, additive stream 116 may be added downstream of the third separation vessel 110. In specific embodiments, antioxidants along with slip-agent and talc may be added downstream of the third separation vessel 110, for example, via a sidearm extruder downstream of the gear pump 111.

Initiators

For the initiator 40 added to the reactor 30, various compositions are considered as suitable; however, the initiators must minimally be effective in the temperature ranges described above for the reactor 30. Free radical initiators may include organic peroxides, such as peresters, perketals, peroxy ketones, percarbonates and cyclic multifunctional peroxides. These organic peroxy initiators are used in conventional amounts, typically from 0.005 to 0.2 wt. % based on the weight of polymerizable monomers. Peroxides may be injected as diluted solutions in a suitable solvent, for example, in a hydrocarbon solvent. Other suitable initiators include azodicarboxylic esters, azodicarboxylic dinitriles and 1,1,2,2-tetramethylethane derivatives, and other components capable of forming free radicals in the desired operating temperature range.

Chain Transfer Agent (CTA)

Chain transfer agents (CTAs) or telogens are used to control the melt index in a polymerization process. Chain transfer involves the termination of growing polymer chains, thus limiting the ultimate molecular weight of the polymer material. Chain transfer agents are typically hydrogen atom donors that will react with a growing polymer chain and stop the polymerization reaction of the chain. These agents can be of many different types, from saturated hydrocarbons or unsaturated hydrocarbons to aldehydes, ketones or alcohols. By controlling the concentration of the selected chain transfer agent, one can control the length of the polymer chains, and, hence the molecular weight, for example, the number average molecular weight, Mn. The melt flow index (MFI or I₂) of a polymer, which is related to Mn, is controlled in the same way.

The chain transfer agents include, but are not limited to, naphthenic hydrocarbons, aliphatic hydrocarbons, such as, for example, propane, pentane, hexane, cyclohexane, n-butane, and isobutane; ketones such as acetone, diethyl ketone or diamyl ketone; aldehydes such as formaldehyde, acetaldehyde, and propionaldehyde; olefins such as propylene and butene; and saturated aliphatic aldehyde alcohols such as methanol, ethanol, propanol or butanol.

Polymers

In one embodiment, the ethylene-based polymers of this invention have a density from 0.914 to 0.930, more typically from 0.916 to 0.930 and even more typically from 0.918 to 0.926, grams per cubic centimeter (g/cc or g/cm3). In one embodiment, the ethylene-based polymers of this invention have a melt index (I₂) from 0.1 to 40 g/10 mins, or from 0.2 to 25 g/10 mins at 190° C./2.16 kg. In some embodiments, the LDPE may have a lower 12 from 0.1 to 10 g/10 mins, or from 0.1 to 1 g/10 mins. Alternatively, the LDPE may have a higher 12 from 5 to 40 g/10 mins, or from 10 to 25 g/10 mins, or from 15 to 25 g/10 mins.

Monomer and Comonomers

The term ethylene-based polymers may refer to homopolymers of ethylene, such as LDPE hompolymer, or copolymers of ethylene and one or more comonomers. Suitable comonomers may include, but are not limited to, ethylenically unsaturated monomers and especially C₃₋₂₀ alpha-olefins, diolefins, polyenes, as well as polar comonomers. These polar comonomers may include but are not limited to those with carboxylic acid, acrylate, or acetate functionality, for example, methacrylic acid, acrylic acid, vinyl acetate, methyl acrylate, isobutylacrylate, n-butylacrylate, glycidyl methacrylate, and monoethyl ester of maleic acid.

Blends

The present ethylene-based polymers can be blended with one or more other polymers, such as, but not limited to, linear low density polyethylene (LLDPE); copolymers of ethylene with one or more alpha-olefins, such as, but not limited to, propylene, butene-1, pentene-1,4-methylpentene-1, pentene-1, hexene-1 and octene-1; and high density polyethylenes (HDPE) having a density of 0.940 to 0.970 g/cc. The amount of the present ethylene-based polymer in the blend can vary widely, but typically it is from 10 to 90, or from 15 to 85, or from 20 to 80, weight percent, based on the weight of the polymers in the blend.

Applications

The LDPE may be employed in a variety of conventional thermoplastic fabrication processes to produce useful articles, including, for example, films; molded articles, such as blow molded, injection molded, or ‘rotomolded articles; foams; wire and cable, fibers, extrusion coatings, and woven or non-woven fabrics.

### EXAMPLES

Test Methods

The test methods include the following:

Melt Index

Melt index I₂ (or I₂) of polymer samples were measured in accordance to ASTM D-1238 (method B) at 190° C. and at 2.16 kg load, respectively.

Density

Samples for density measurement were prepared according to ASTM D4703. Measurements were made, according to ASTM D792, Method B, within one hour of sample pressing.

### Examples 1 and 2

For the experimental pilot plant set up, two commercially available Dow grades were used—LDPE 780E, which has a melt index of 20 g/10 min (Example 1), and LDPE 150E (Example 2) which has a melt index of 0.25 g/10 min. Nitrogen purged pellets were fed to a single screw extruder used to melt the pellets and forward the molten material to the a separator. The line between the extruder and the separator was equipped with heating oil and static mixer elements. This line was used to control the overall temperature of the separator. Ethylene was introduced upstream of the static mixing elements to ensure good mixing before the separator. The ethylene was supplied and metered using bottled ethylene and a flowmeter and control valve. The molten polymer and ethylene mix stream was fed to a separator with vacuum capabilities. The separator was equipped with temperature and pressure instrumentation. A gear pump was attached to the bottom of the separator which fed a single molten strand to a water bath. Emerging from the water bath, the strand was air dried and fed to a strand chopper. The pellets were collected on the outlet of the strand chopper and measured for ethylene volatiles. Additional process conditions are provided in Tables 1 and 2 below.

### Example 1—LDPE 780 E with (I₂) of 20 g/10 Mins

In Example 1, multiple pilot plant separation experiments were performed in the synthesis process of DOW™ LDPE 780 E, which is a commercially available LDPE from The Dow Chemical Company, Midland, Mich. having a density of 0.923 g/cc and an I₂ of 20 g/10 mins. As shown in Table 1, Inventive Examples 1 and 2, which were devolatilized in a third separation vessel operating at vacuum pressures at 0.05 bar and below, achieved a final LDPE product having an unreacted ethylene monomer content of 11 ppm or 20 ppm, respectively, without using any stripping agent, whereas Comparative Examples A and B included 1 and 2 wt % respectively of water stripping agent to reduce the unreacted ethylene monomer content.

TABLE 1

| | | | | Unreacted | | Final Unreacted |
|---|---|---|---|---|---|---|
| | | | | Ethylene | | Ethylene |
| | | Third | Third | Monomer in | | Monomer in |
| | LDPE | Separation | Separation | the Polymer | Stripping | LDPE Product |
| | Polymer | Vessel | Vessel | Feed Before | Agent | After |
| | Feed | Temperature | Pressure | Devolatilization | (Water) | Devolatilization |
| | (kg/hr) | (° C.) | (bar) | (ppm) | %. Wt. | (ppm) |
| Inventive | 7.25 | 260 | 0.03 | 3500 | 0 | 11 |
| Example 1 | | | | | | |
| Inventive | 7.25 | 260 | 0.05 | 1000 | 0 | 20 |
| Example 2 | | | | | | |
| Comparative | 7.25 | 260 | 0.05 | 3500 | 1 | 5 |
| Example A | | | | | | |
| Comparative | 7.25 | 260 | 0.4 | 3500 | 2 | 22 |
| Example B | | | | | | |

### Example 2— LDPE 150 E with (I₂) of 0.25 g/10 Mins

In Example 2, multiple pilot plant separation experiments were also performed in the synthesis process of DOW™ LDPE 150 E, which is a commercially available LDPE from The Dow Chemical Company, Midland, Mich. having a density of 0.921 g/cc and an I₂ of 0.25 g/10 mins. As shown in Table 2, Inventive Examples 3 and 4, which were devolatilized in a third separation vessel operating at vacuum pressures of 0.03 bar, achieved a final LDPE product having an unreacted ethylene monomer content of 32 ppm or 21 ppm, respectively, whereas Comparative Example D included 1 wt % of water stripping agent to reduce the unreacted ethylene monomer content. Inventive Example 3 achieved the unreacted ethylene monomer removal at a lower temperature of 230° C. In contrast, Comparative Example C utilized a third separation vessel operating at a pressure greater than 0.05 bar of pressure, and unsatisfactorily achieved a final LDPE product having an unreacted ethylene monomer content of 104 ppm. Moreover, Comparative Example E utilized a third separation vessel operating at a pressure greater than 0.05 bar of pressure— 0.15 bar—as well as 1 wt. % stripping agent, yet failed to reduce the unreacted ethylene monomer content to 50 ppm or below.

TABLE 2

| | | | | Unreacted | | Final Unreacted |
|---|---|---|---|---|---|---|
| | | | | Ethylene | | Ethylene |
| | | Third | Third | Monomer in | | Monomer in |
| | LDPE | Separation | Separation | the Polymer | Stripping | LDPE Product |
| | Polymer | Vessel | Vessel | Feed Before | Agent | After |
| | Feed | Temperature | Pressure | Devolatilization | (Water) | Devolatilization |
| | (kg/hr) | (° C.) | (bar) | (ppm) | %. Wt. | (ppm) |
| Inventive | 5.25 | 230 | 0.03 | 3500 | 0 | 32 |
| Example 3 | | | | | | |
| Inventive | 5.25 | 260 | 0.03 | 3500 | 0 | 21 |
| Example 4 | | | | | | |
| Comparative | 5.25 | 260 | 0.06 | 3500 | 0 | 104 |
| Example C | | | | | | |
| Comparative | 5.25 | 230 | 0.05 | 3500 | 1 | 17 |
| Example D | | | | | | |
| Comparative | 5.25 | 230 | 0.15 | 3500 | 1 | 60 |
| Example E | | | | | | |

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A method for reducing unreacted ethylene monomer in a low density polyethylene (LDPE) polymerization process comprising:
delivering a monomer feedstock comprising ethylene monomer to a compressor system to produce a pressurized feedstock having a pressure of at least 2000 bar;
passing the pressurized feedstock to at least one free radical polymerization reactor to produce a reactor effluent comprising the LDPE and unreacted ethylene monomer;
delivering the reactor effluent to a separation system comprising a first separation vessel, a second separation vessel, and a third separation vessel in series, the third separation vessel having an operating pressure of less than or equal to 0.05 bar, wherein the third separation vessel produces a separation product comprising LDPE and less than or equal to 50 ppm of the unreacted ethylene monomer, wherein there is no stripping agent added upstream of the third separation vessel; and
adding additives into the separation system upstream of the third separation vessel, wherein the additives are added between the second separation vessel and the third separation vessel.

2. The method of claim 1, further comprising pelletizing the separation product without a subsequent purging step.

3. (canceled)

4. (canceled)

5. The method of claim 1, wherein less than 200 ppm of additives is added.

6. The method of claim 1, wherein the separation product comprises less than or equal to 30 ppm of unreacted ethylene monomer.

7. The method of claim 1, wherein the third separation vessel operates at a temperature from 180 to 260° C.

8. The method of claim 1, wherein the first separation vessel operates at a pressure of 150 to 350 bar.

9. The method of claim 1, wherein the second separation vessel operates at a pressure from 1 to 5 bar.

10. The method of claim 1, wherein the separation system includes a letdown valve disposed between the first separation vessel and the second separation vessel.

11. The method of claim 1, wherein the compressor system comprises a primary compressor and a secondary compressor downstream of the primary compressor.

12. The method of claim 11, wherein the primary compressor raises the pressure of the monomer feedstock to a pressure of at least 200 bar prior to feeding to the secondary compressor.

13. The method of claim 1, wherein the free radical polymerization reactor comprises at least one tubular reactor, or at least one autoclave reactor.

14. The method of claim 1, wherein the reactor effluent is passed to a letdown valve upstream of the separation system.

15. The method of claim 1, wherein the monomer feedstock comprises C₃-C₁₂ olefin comonomer or polar comonomer.
